(19) United States
(12) Patent Application Publication
(10) Pub. No.: US 2019/0318416 A1
(43) Pub. Date: Oct. 17, 2019

(54) System and Method for Providing Photography

(71) Applicant: Christopher Koh, Seattle, WA (US)

(72) Inventor: Christopher Koh, Seattle, WA (US)

(21) Appl. No.: 16/372,686

(22) Filed: Apr. 2, 2019

Related U.S. Application Data
(60) Provisional application No. 62/656,864, filed on Apr. 12, 2018.

(51) Int. Cl. G06Q 30/06; G06F 21/16; G06Q 20/10

(52) U.S. Cl. CPC G06Q 30/0635; G06F 2221/0733; G06Q 20/10; G06F 21/16

(57) ABSTRACT

An online method facilitates the discovery of a specific user by a plurality of photographers located in the vicinity of the user and delivery of photos produced by at least one photographer to the specific user. The method provides the plurality of photographers with location data, a photo, and/or at least one set of bioinformatics data of the specific user. After the at least one photographer identifies the specific user and produces photos of the specific user, the method sends over the photos captured by the at least one photographer. Further, the method provides the specific user with protected photos for free. However, the method provides original photos captured by the at least one photographer when the specific user agrees to and makes the purchase payment based on the predetermined prices set by the administrator and/or the photographer.

The current application claims a priority to the U.S. Provisional Patent application Ser. No. 62/656,864 filed on Apr. 12, 2018.

### FIELD OF THE INVENTION

The present invention relates generally to photography. More specifically, the present invention is a system and method to facilitate the discovery of a user by at least one photographer located in the vicinity of the user and delivery of photographic images captured by the at least one photographer to the user.

### BACKGROUND OF THE INVENTION

As the use of personal computing (PC) devices such as a smartphone grows rapidly, photography including candid photography using these devices is increasingly becoming popular in general day to day photography. More and more users prefer candid photos to traditional staged photos. Candid photography is any type of photography that is real and in the moment. In this type of photography, there are no posing, no manufactured smiles, only true and genuine feelings. The users may know that they are being photographed, but they are not taken out of the moment by a camera's presence, resulting in a candid photo that allows the user's genuine emotion to shine through. Normally, candid photography is achieved in many ways such as when the user is in motion, by avoiding prior preparation of the user, by surprising the user, and/or by not distracting the user during the process of taking photos.

Often a user desires to capture photos in a live event for the remembrance of the event. However, one of the problems while capturing a photo is that the user may need someone else to capture the photograph. There may be currently no easily available or accessible method for users to capture photos of themselves. Many systems and methods are usually directed to a single event and are not suitable for capturing the performance, natural course of action, etc., of the user at the event. Further, these methods do not provide the user in an event with photographs of any friends, family, and/or loved ones which are reflective of the user's day or night at the event. Other systems and methods such as the ones used in amusement park rides (roller coast rides and/or water rides) provide limited photographs at certain locations of a ride for the user during the ride. These systems do not enable the user to obtain photographs which the user desires for the entire event. Another method to providing photos of the user in an event such as a wedding is to hire a professional photographer. While this method often provides high quality of photos, the photos may be costly for the user to purchase. Additionally, the photos taken by the photographer may not meet the specific needs of the user and the user may be forced to purchase desired photos from the photographer in expensive packages containing unwanted photos. Another way is to ask someone else in a group to capture the photo of others in the group, but the user may not rely on someone else to capture the photo and the person taking the photo may not come within the frame of the photo since the person may be holding the camera.

Therefore, it is the object of the present invention to provide a solution to the afore-mentioned problems and/or limitations. The present invention provides an innovative and improved system and method to facilitate the discovery of the user by at least one photographer in the vicinity of the user and delivery of photos captured by the at least one photographer to the user.

### SUMMARY OF THE INVENTION

An online system and method facilitates the discovery of a specific user by a plurality of photographers located in the vicinity of the specific user and delivery of photos captured by at least one photographer to the specific user. The method provides the plurality of photographers with a photograph, biometrics data, location data and/or orientation data of the specific user using a communication device such as Bluetooth, RFID, and Wi-Fi, etc. Additionally, the method obtains the location data of the specific user using a Global Positioning System (GPS) that is equipped on the corresponding personal computing (PC) device of the specific user. Subsequently, the method relays and displays on the PC device of the plurality of photographers the actual location of the specific user. Then, the at least one photographer from the plurality of photographers who decides to take the photographing job, identifies the specific user using the profile information including a photo of the specific user. Further, the method provides the at least one photographer with facial recognition technology to identify the specific user for the photography job. After successfully locating and identifying the specific user, the at least one photographer confirms with and sends photos to the remote server through the PC devices for the photographing job. Subsequently, the method sends photos captured by the at least one photographer to the specific user. Further, the method provides protected photos to the specific user and allows the specific user to download the photos protected using watermarks, blurring, or any other suitable method. However, the method provides original photos captured by the at least one photographer when the specific user agrees and makes the purchase payment based on the prices pre-specified by the administrator of the remote server and/or the at least one photographer. Then, the method directs the purchase payment to the at least one photographer. Additionally, the method allows the specific user to specify a price for each photo and sends the price to the plurality of the photographer accounts before a confirmation is made by any of the plurality of the photographer accounts to photograph the specific user. Further, the method provides interfaces of discovery control and time control to the specific user. The discovery control interface allows the specific user to activate and deactivate the discovery of the location of the specific user by any of the plurality of the photographer accounts. Furthermore, the time control interface offers the specific user to specify a time period for the need of the photography.

### BRIEF DESCRIPTION OF THE DRAWINGS

FIG. 1 is a block diagram illustrating the system overview of the present invention.

FIG. 2 is a flowchart illustrating the overall process followed by the method of the present invention.

FIG. 3 is a flowchart illustrating a sub-process for displaying the location of each of a plurality of photographers to a specific user of the present invention.

FIG. 4 is a flowchart illustrating a sub-process for facilitating the identification of a specific user by a plurality of photographers of the present invention.

FIG. 5 is a flowchart illustrating a sub-process for providing the specific user account with a discovery control interface to activate and deactivate the need of photography by the method of the present invention.

FIG. 6 is a flowchart illustrating a sub-process for providing the specific user account with a time control interface to specify the time period for the need of photography by the method of the present invention.

FIG. 7 is a flowchart illustrating a sub-process for protecting each photo of the present invention.

FIG. 8 is a flowchart illustrating a sub-process for protecting each photo with watermark of the present invention.

FIG. 9 is a flowchart illustrating a sub-process for providing protected photos that are blurred of the present invention.

FIG. 10 is a flowchart illustrating a sub-process for providing at least one photo after payment to a specific user account of the present invention.

FIG. 11 is a flowchart illustrating a sub-process for providing a purchase price for each desired photo from the specific user account to a plurality of photographer accounts by the method of the present invention.

FIG. 12 is a flowchart illustrating a sub-process for a plurality of photographers to accept a purchase price for each desired photo from the specific user account of the present invention.

FIG. 13 is a flowchart illustrating a sub-process for relaying the confirmation of providing photography from each of the plurality of photographers to the specific user of the present invention.

### DETAIL DESCRIPTIONS OF THE INVENTION

All illustrations of the drawings are for the purpose of describing selected versions of the present invention and are not intended to limit the scope of the present invention.

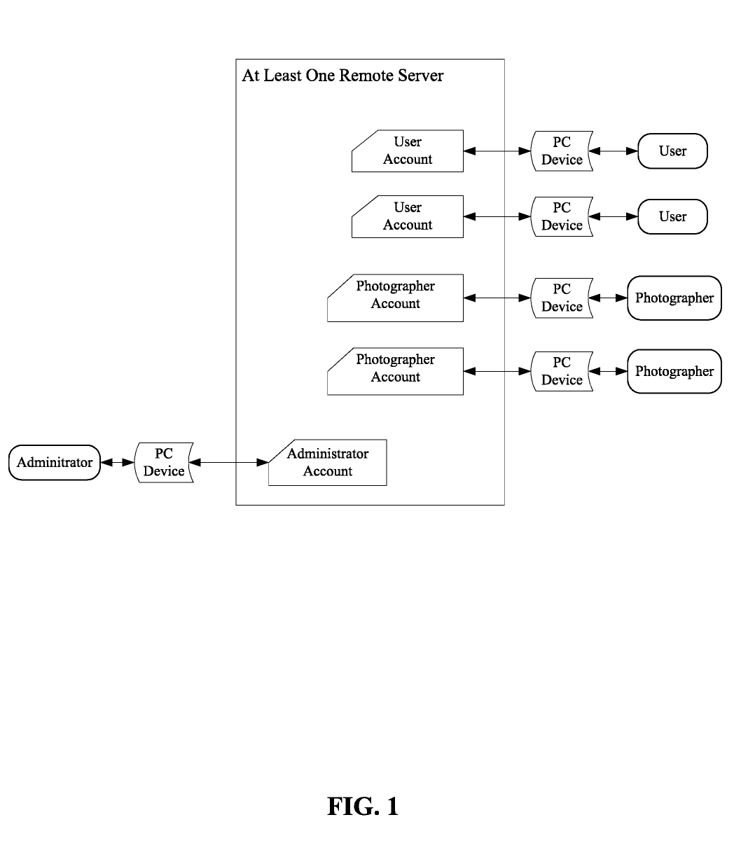

As can be seen in FIG. 1 to FIG. 8, the present invention provides an innovative and improved system and method to facilitate the discovery of the user by at least one photographer in the vicinity of the user and delivery of photos captured by the at least one photographer to the user. More specifically, the method of the present invention obtains the location data of the specific user using a Global Positioning System (GPS) that is equipped on the corresponding personal computing (PC) device of the specific user. Subsequently, the method sends a photograph, biometrics data, location data and/or orientation data of the specific user to a plurality of photographers using a communication device such as Bluetooth, RFID, and Wi-Fi, etc. After successfully locating and identifying the specific user, the at least one photographer confirms with and sends photos to the remote server through the PC devices for the photographing job. Further, the method provides protected photos to the specific user and allows the specific user to download the photos protected using watermarks, blurring, or any other suitable method. However, the method provides original photos captured by the at least one photographer when the specific user agrees and makes the purchase payment based on the prices pre-specified by the administrator of the remote server and/or the at least one photographer. After receiving the payment, the method directs the purchase payment to the at least one photographer. Additionally, the method allows the specific user to specify a price for each photo and sends the price to the plurality of the photographer accounts before a confirmation is made by any of the plurality of the photographer accounts to photograph the specific user. Further. the method provides the specific user account with interfaces of discovery control and time control. The discovery control interface enables the specific user to activate and deactivate the discovery of the location of the specific user by any of the plurality of the photographer accounts. Furthermore, the time control interface allows the specific user to specify a time period for the need of the photography.

In particular, the system of the present invention can facilitate a special type of photography—candid photography, which is any type of photography that is real and in the moment. In this type of photography, there are no posing, no manufactured smiles, only true and genuine feelings. The users may know that they are being photographed, but they are not taken out of the moment by a camera's presence, resulting in a candid photo that allows the user's genuine emotion to shine through. Normally, candid photography is achieved in many ways such as when the user is in motion and/or conducting normal or planned business, by avoiding prior special preparations of the user and surroundings, by surprising the user, and/or by not distracting the user during the process of taking photos.

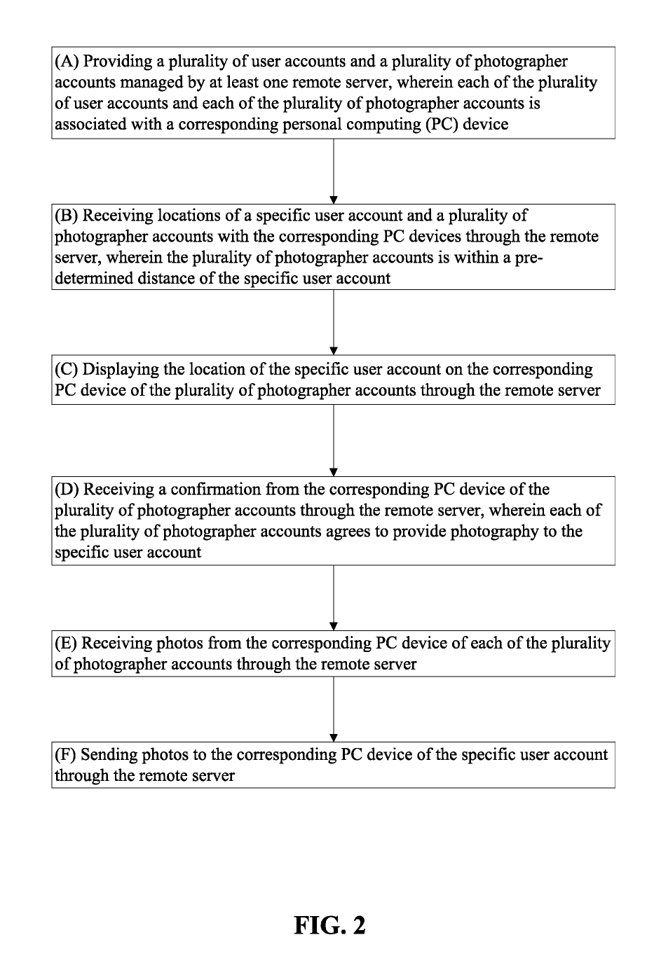

As can be seen in FIG. 1, the method of the present invention comprises a system and method to manage the photography between a plurality of users and a plurality of photographers. To accomplish this, the method of the present invention associates each of the plurality of users with a unique user account from a plurality of user accounts and each of the plurality of photographers with a unique photographer account from the plurality of photographer accounts that are managed by at least one remote server (Step A), as seen in FIG. 2. Each of the plurality of user accounts and each of the plurality of photographer accounts is associated with a corresponding personal computing (PC) device. The corresponding PC device allows a user and/or a photographer to interact with the present invention and can be, but is not limited to, a smartphone, a smart watch, a laptop, a desktop, or a tablet PC. The users of the user accounts may include relevant parties such as, but are not limited to, individuals, managers, business owners, wedding planners, event organizers, consumers, companies, corporations, associations, government entities, and administrators. The photographers of the photographer accounts may include relevant parties such as, but are not limited to, professional photographers, party photographers, studio photographers, sports photographers, wedding photographers, event photographers, magazine photographers, fashion photographers, concert photographers, photojournalists, companies, corporations, photography business managers, photography business owners, administrators, etc. Further, the at least one remote server is used to manage the photography platform for the plurality of user accounts and the plurality of photographer accounts. The remote server can be managed through an administrator account by an administrator as seen in FIG. 1. The administrator who manages the remote server includes, but is not limited to, technician, engineer, system specialist, software engineer, consultant, manager, executive officer, chief operating officer, chief technology officer, chief executive officer, president, company, corporation, organization, etc. Moreover, the remote server is used to execute a number of internal software processes and store data for the present invention. The software processes may include, but are not limited to, server software programs, web-based software applications or browsers embodied as, for example, but not limited to, websites, web applications, desktop applications, and mobile applications compatible with a corresponding user PC device. Additionally, the software processes may store data into internal databases and communicate with external databases, which may include but are not limited to map databases (such as Google Maps®), personal information databases, databases maintaining data about photographers, etc. The interaction with external databases over a communication network may include, but is not limited to, the Internet.

As can be seen in FIG. 2, the overall process of the method of the present invention receives locations of a specific user account and a plurality of photographer accounts with the corresponding PC device through the remote server, wherein the plurality of photographer accounts is within a pre-determined distance of the specific user account (Step B). More specifically, the method receives a location of the specific user account when the system of the present invention is activated on the corresponding PC device of the specific user account and the corresponding PC device of the plurality of photographer accounts. This automatically allows the method to locate and receive the locations of the user of the specific user account and any photographer of the plurality of photographer accounts within a pre-determined distance of the specific user account. The pre-determined distance related to the physical location of the specific user is specified by the specific user account including, but not limited to, feet, miles, township, city, etc. Additionally, the method of the present invention obtains the location data of the specific user using a Global Positioning System (GPS) that is equipped on the corresponding personal computing (PC) device of the specific user and the PC device of any photographer of the plurality of photographer accounts.

Subsequently, the method displays the location of the specific user account on the corresponding PC device of the plurality of photographer accounts through the remote server (Step C). More specifically, the method sends and displays the location information of the specific user account to the corresponding PC device of any of the plurality of photographer accounts within the pre-determined distance of the specific user while any of the plurality of photographer accounts with the system of the present invention deactivated will not receive such location information. Furthermore, the method may relay a photo and/or other personal information of the specific user to the corresponding PC device of each of the plurality of photographer accounts. Once receiving the location and personal information of the specific user account, each of the plurality of photographers can review the information for the specific user account and decides whether or not to take the photography job for the specific user account. Further, the method receives a confirmation from the corresponding PC device of the plurality of photographer accounts through the remote server, wherein each of the plurality of photographer accounts agrees to provide photography to the specific user account (Step D). While the specific user performs planned or normal activities thereafter, the plurality of photographers takes photos of the specific user through the activities. The plurality of photographers takes photos for the specific user, and anybody involved in the activities, including, but not limited to, friends, colleagues, family members, relatives, etc., who may not know that they are being photographed with the specific user. As the photos are being produced, the method receives photos from the corresponding PC device of each of the plurality of photographer accounts through the remote server (Step E). Further, the method sends photos to the corresponding PC device of the specific user account through the remote server (Step F). Thus, the specific user can review the photos instantly.

The overall process of the method of the present invention, as seen in FIG. 2 and described above, also applies to a particular type of photography: candid photography, wherein the specific user may know that a plurality of photographers is taking photos of the specific user, surroundings and any people that the specific user interacts with in a situation including, but not limited to, an event, activity, meeting, etc.

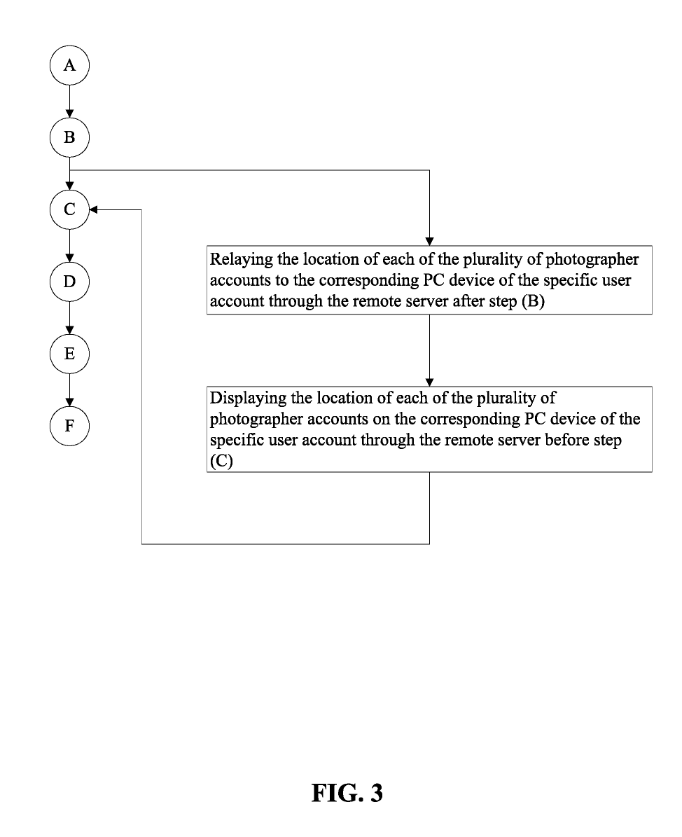

As can be seen in FIG. 3, the method of the present invention provides a sub-process to display the location of each photographer of the plurality of photographer accounts within the pre-determined distance of the specific user account after Step B. and displays the location of each of the plurality of photographer accounts on the corresponding PC device of the specific user account through the remote server in Step C. This sub-process notifies the specific user the available photographers within the pre-determined distance of the specific user account.

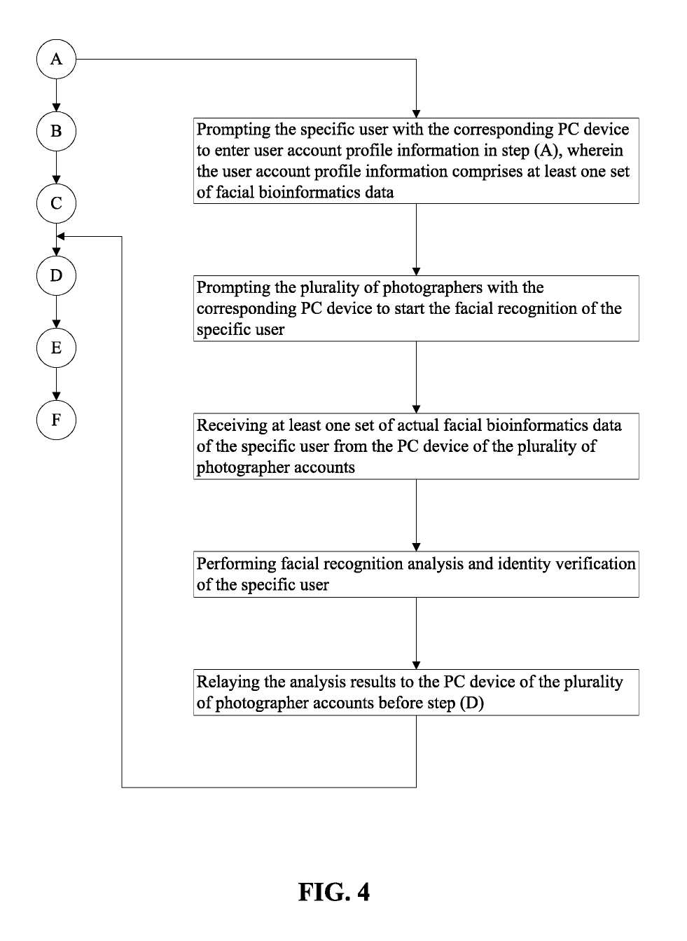

As can be seen in FIG. 4, the method of the present invention provides a sub-process for the plurality of photographers to identify the specific user. More specifically, the method prompts the specific user with the corresponding PC device to enter user account profile information in Step A, wherein the user account profile information comprises at least one set of facial bioinformatics data. Subsequently, the method prompts the plurality of photographer with the corresponding PC device to start the facial recognition of the specific user and receives at least one set of actual facial bioinformatics data of the specific user from the PC device of the plurality of photographer accounts when such data is made available by the plurality of photographers. With internal algorithms of the present invention, the method performs facial recognition analysis and identity verification of the specific user. Further, the method relays the analysis results to the PC device of the plurality of photographer accounts before Step D. In this sub-process, the method of the present invention utilizes the most advanced artificial intelligence (AI) technologies for facial recognition, which are incorporated in the analysis algorithms and include, but are not limited to, pattern matching, texture matching, template matching, 3-dimensional recognition, skin texture analysis, etc. Further, the at least one set of facial bioinformatics data of the specific user include, but is not limited to, facial image, facial video, etc.

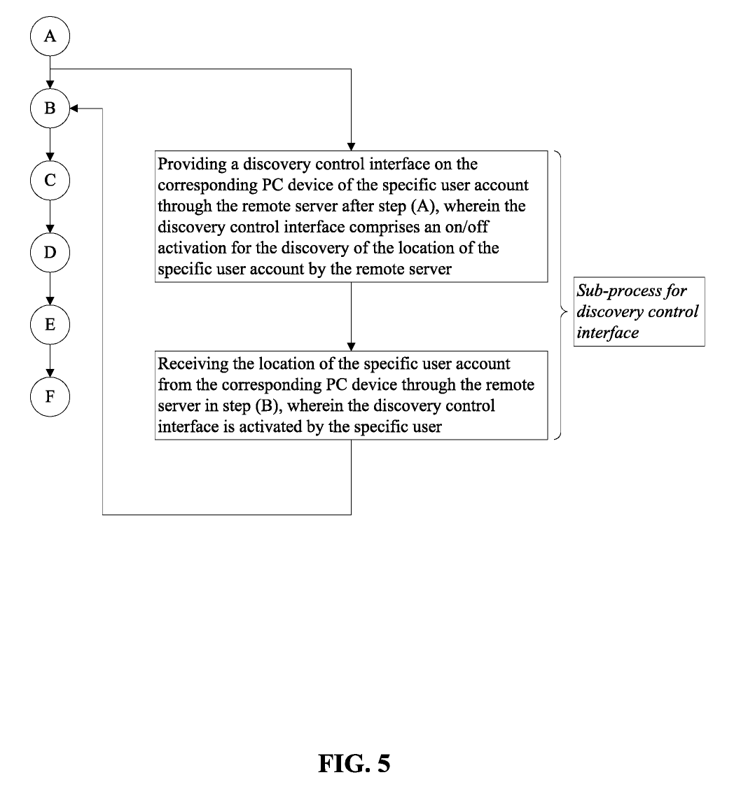

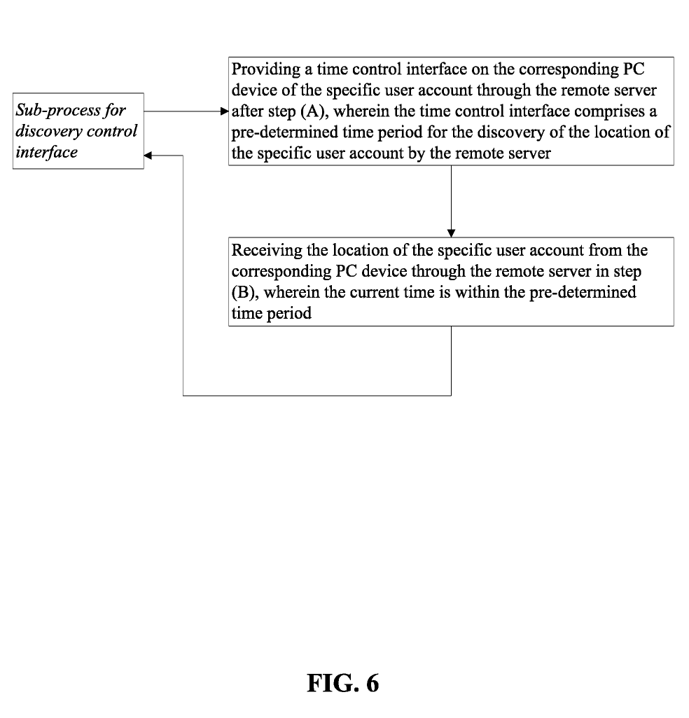

As can be seen in FIG. 5, the method of the present invention provides a sub-process to allow the specific user to control the discovery of the location of the specific user and thus activates or deactivates the request for photography. More specifically, the method provides a discovery control interface on the corresponding PC device of the specific user account through the remote server after Step A, wherein the discovery control interface comprises an on/off activation for the discovery of the location of the specific user account by the remote server. Subsequently, the method receives the location of the specific user account from the corresponding PC device through the remote server in Step B, wherein the discovery control interface is activated by the specific user. The discovery control interface can include, but is not limited to, an on/off switch, a button for activation/deactivation, a control knob, and any other suitable control. Once the discovery control interface is deactivated, the method will not receive location information of the specific user account, thus, the specific user account will not be provided with photography. In an alternative embodiment of the present invention, as can be seen in FIG. 6, the sub-process for discovery control interface provides a time period during which photography for the specific use account is needed. More specifically, the method provides a time control interface on the corresponding PC device of the specific user account through the remote server after Step A, wherein the time control interface comprises a pre-determined time period for the discovery of the location of the specific user account by the remote server. Subsequently, the method receives the location of the specific user account from the corresponding PC device through the remote server in Step B, wherein the current time is within the pre-determined time period. Further, the time control interface can include, but is not limited to, a slider bar control, a rotary hour/minute control, a digital timer, a digital clock, a digital time specifier, and any other suitable control. Once the time period specified by the specific user account expires, the location discovery of the specific user is deactivated.

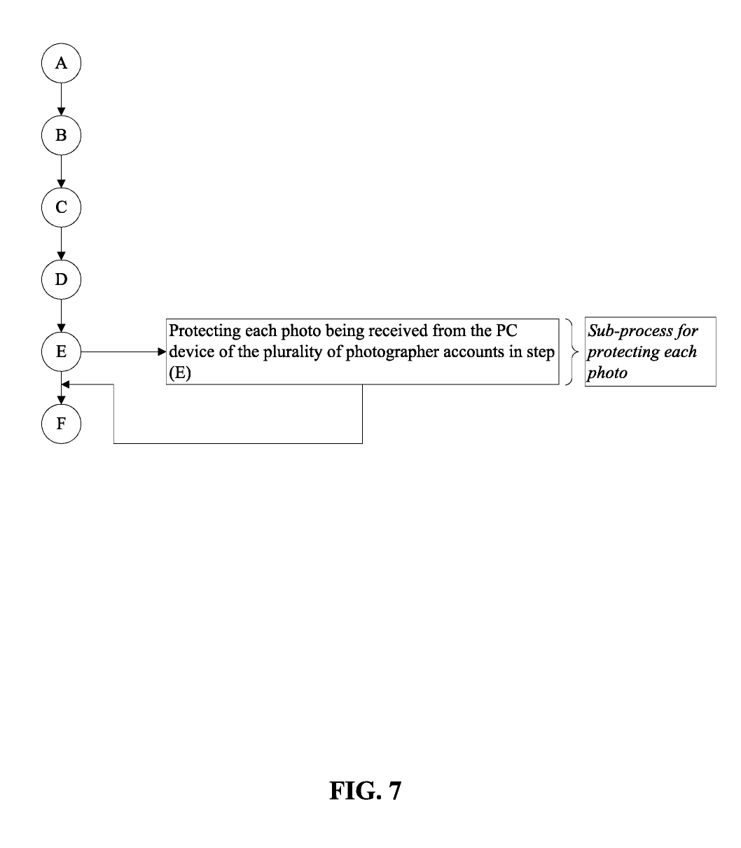

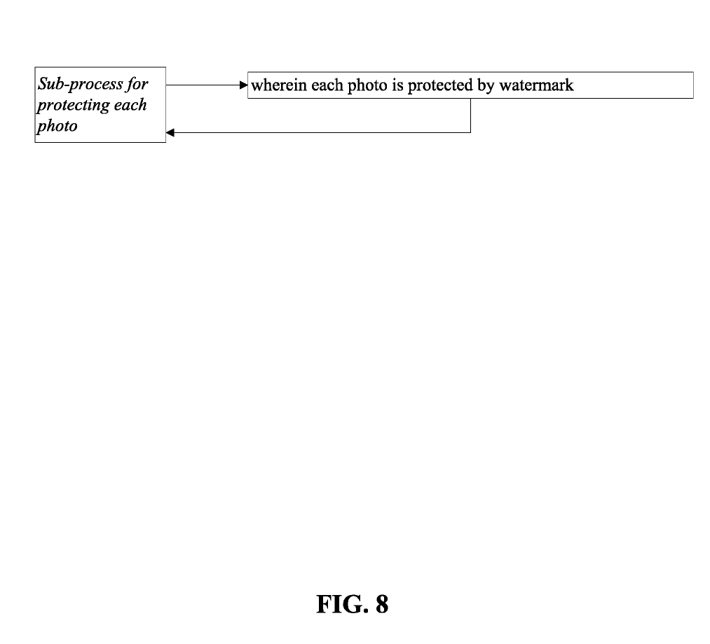

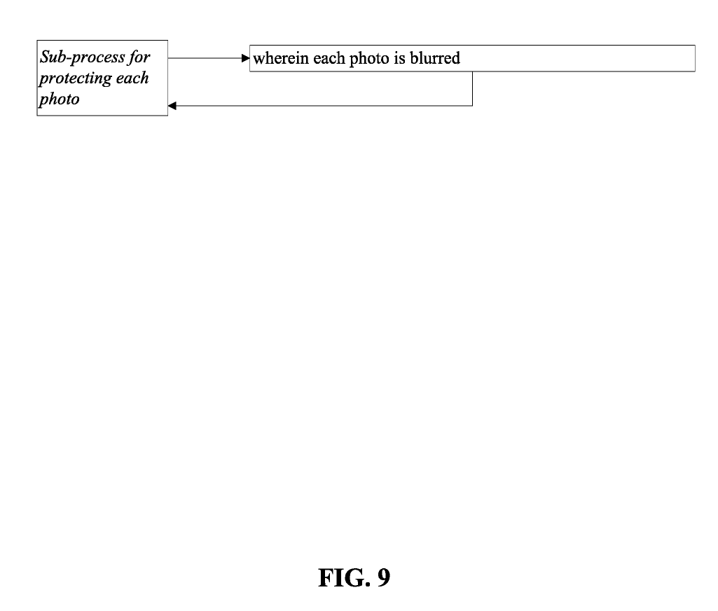

As can be seen in FIG. 7, the method of the present invention comprises a sub-process for protecting each photo being sent to the specific user account for review. More specifically, the method protects each photo being received from the PC device of the plurality of photographer accounts in Step E. Each original photo produced by the plurality of photographers is protected before being sent to the specific user for review. One specific protection means used by the method can be watermark. Specifically, the watermark method for each protected photo includes, but is not limited to, printing or overlaying the photo with letters, words, logos, copyright statements, etc., as seen in FIG. 8. In an alternative embodiment, as can be seen in FIG. 9, the sub-process of the method of the present invention protects each photo being sent to the specific user account in Step E, wherein each photo is blurred. Other suitable methods for protecting each photo being sent to the specific user for review can used in the method of the present invention. However, only unprotected, original photos are sent to the specific user after the specific user made a proper payment through the method, which is then sent to the specific photographer.

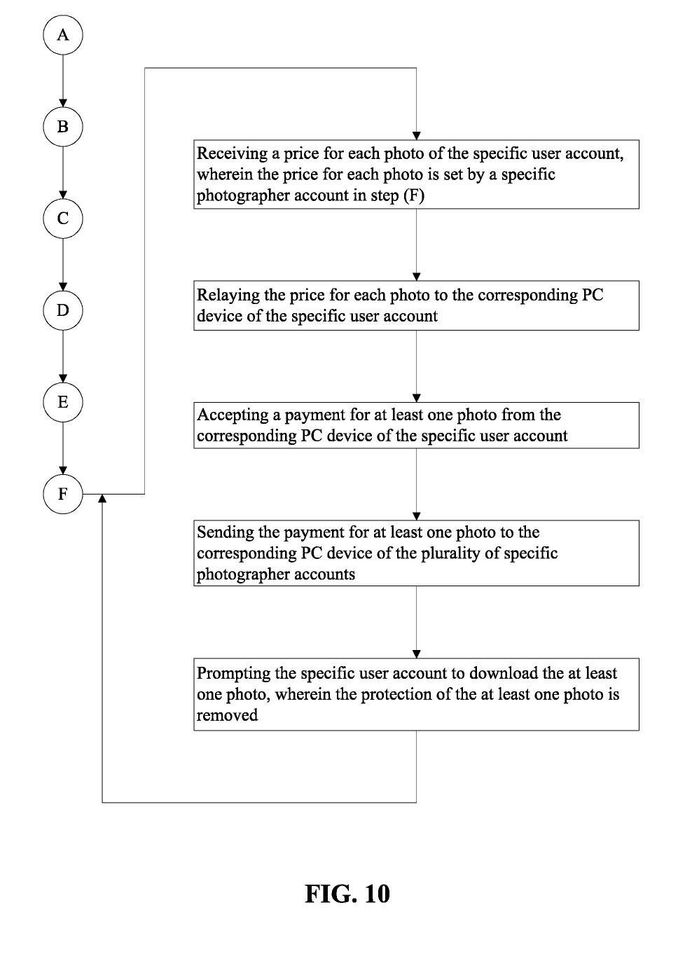

As can be seen in FIG. 10, the method of the present invention provides a sub-process to send at least one photo to the specific user account after payment is made by the specific user. More specifically, the method receives a price for each photo of the specific user account, wherein the price for each phot is set by a specific photographer account in Step F. For each photo produced by the specific photographer and received by the remote server, the method receives a corresponding price from the specific photographer, wherein the price for each photo can be the same, or variable, or including, but not limited to, a bundle price, a large quantity discounted price, etc. Subsequently, the method relays the price for each photo to the corresponding PC device of the specific user account. Once the specific user makes a payment, the method accepts the payment for at least one photo from the corresponding PC device of the specific user account. The method sends the payment for at least one photo to the corresponding PC device of the plurality of specific photographer accounts and prompts the specific user account to download the at least one photo, wherein the protection of the at least one photo is removed. Subsequently, the method provides the specific user with the original photo(s) that the specific user has paid for. In an alternative embodiment of the present invention, the method provides a price for each phot of the specific user account, wherein the price for each photo is set by the administrator of the remote server. This embodiment offers the administrator of the system and remote server the price setting right besides the photographer who may have contractual agreement with the administrator.

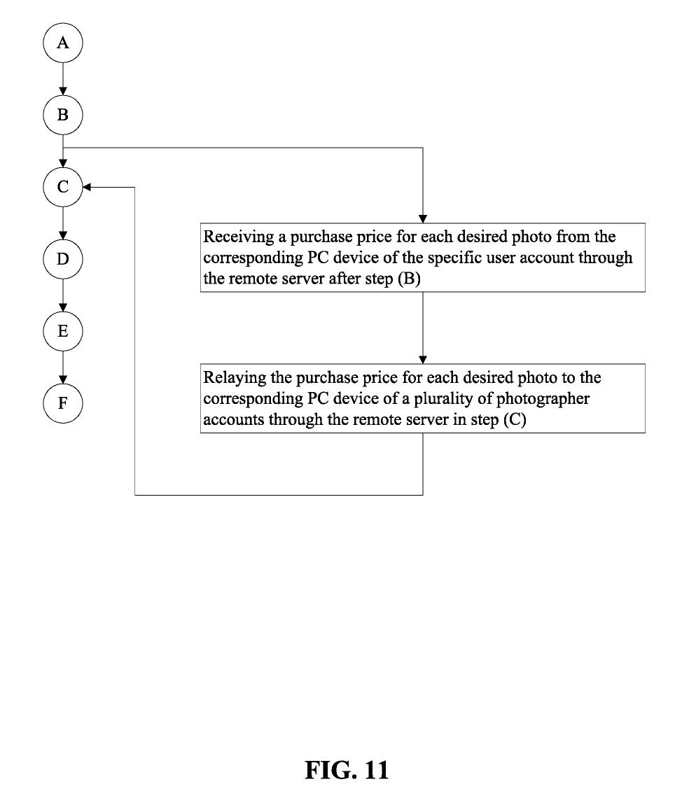

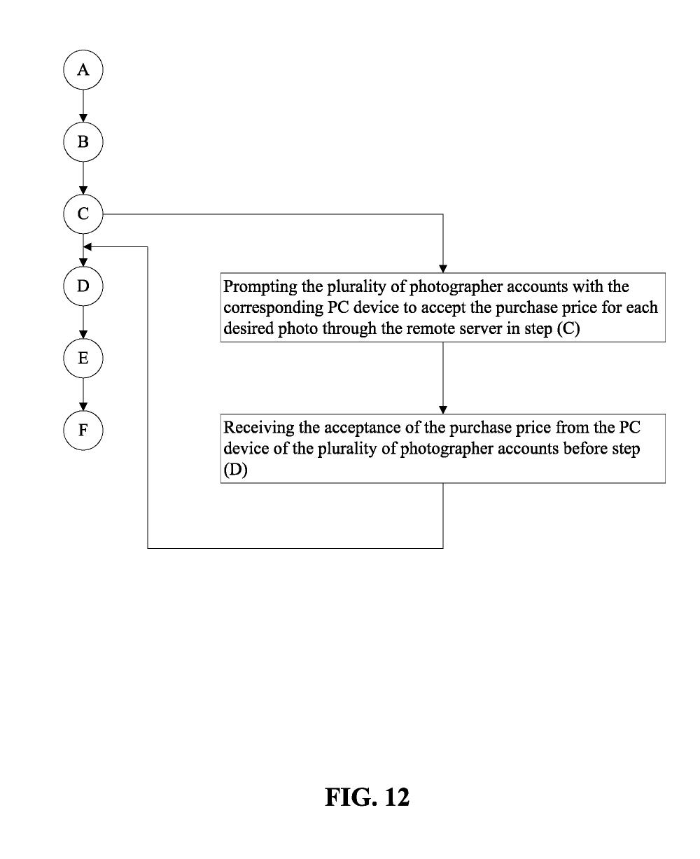

As can be seen in FIG. 11, the method of the present invention provides a sub-process to enable the specific user to specify a price for each desired photo before any of the plurality of photographer accounts accepts the photography job. More specifically, the method receives a purchase price for each desired photo from the corresponding PC device of the specific user account through the remote server after Step B. Subsequently, the method relays the purchase price for each desired photo to the corresponding PC device of a plurality of photographer accounts through the remote server in Step C. Thus, when a photographer accepts and confirms with the corresponding PC device the photography job for the specific user, the specific photographer agrees with the purchase price for each photo that the specific user desires when available. As can be seen in FIG. 12, the method prompts the plurality of photographer accounts with the corresponding PC device to accept the purchase price for each desired photo through the remote server in Step C. Once accepted, the method receives the acceptance of the purchase price from the PC device of the plurality of photographer accounts before Step D. The acceptance of the specific user's price is then directed to the specific user as part of the confirmation of the photography job by the plurality of photographers with the corresponding PC device.

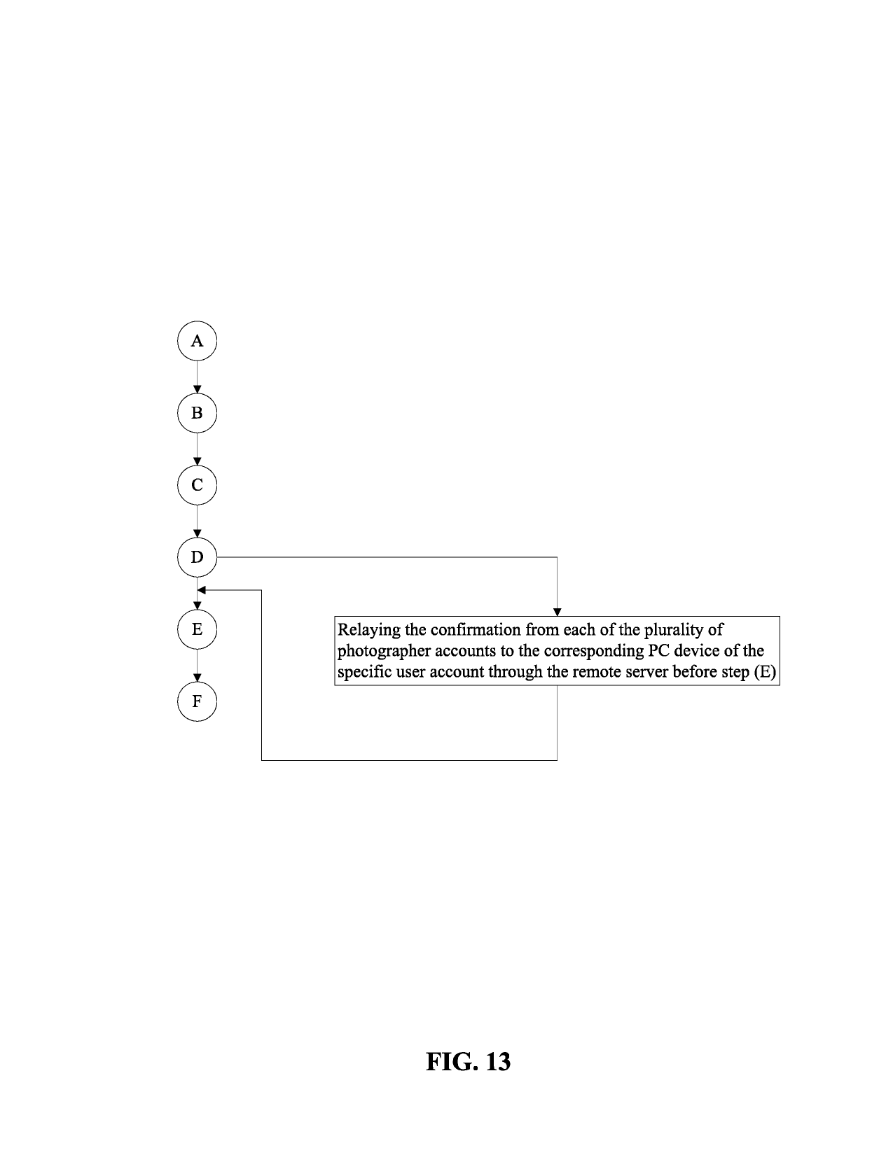

As can be seen in FIG. 13, the method of the present invention provides a sub-process to relay the confirmation of providing photography from each of the plurality of photographers to the specific user. More specifically, the method relays the confirmation from each of the plurality of photographer accounts to the corresponding PC device of the specific user account through the remote server before Step E. This sub-process notifies the specific user that whichever photographer agrees to take up the photography job also accepts the desired price for each photo that the specific user purchases when available.

Although the invention has been explained in relation to its preferred embodiment, it is to be understood that many other possible modifications and variations can be made without departing from the spirit and scope of the invention as hereinafter claimed.

What is claimed is:

1. A method for providing photography comprising the steps of:
(A) providing a plurality of user accounts and a plurality of photographer accounts managed by at least one remote server, wherein each of the plurality of user accounts and each of the plurality of photographer accounts is associated with a corresponding personal computing (PC) device;
(B) receiving locations of a specific user account and a plurality of photographer accounts with the corresponding PC devices through the remote server, wherein the plurality of photographer accounts is within a pre-determined distance of the specific user account;
(C) displaying the location of the specific user account on the corresponding PC device of the plurality of photographer accounts through the remote server;
(D) receiving a confirmation from the corresponding PC device of the plurality of photographer accounts through the remote server, wherein each of the plurality of photographer accounts agrees to provide photography to the specific user account;
(E) receiving photos from the corresponding PC device of each of the plurality of photographer accounts through the remote server; and
(F) sending photos to the corresponding PC device of the specific user account through the remote server.

2. The method for providing photography as claimed in claim 1, wherein the photography comprises candid photography.

3. The method for providing photography as claimed in claim 1 comprising the steps of:
relaying the distance of each of the plurality of photographer accounts from the specific user to the corresponding PC device of the specific user account through the remote server after step (B); and
displaying the distance of each of the plurality of photographer accounts on the corresponding PC device of the specific user account through the remote server in step (C).

4. The method for providing photography as claimed in claim 1 comprising the steps of:
relaying the location of each of the plurality of photographer accounts to the corresponding PC device of the specific user account through the remote server after step (B); and
displaying the location of each of the plurality of photographer accounts on the corresponding PC device of the specific user account through the remote server in step (C)

5. The method for providing photography as claimed in claim 1 comprising the steps of:
prompting the specific user with the corresponding PC device to enter user account profile information in step (A), wherein the user account profile information comprises at least one set of facial bioinformatics data;
prompting the plurality of photographers with the corresponding PC device to start the facial recognition of the specific user;
receiving at least one set of actual facial bioinformatics data of the specific user from the PC device of the plurality of photographer accounts;
performing facial recognition analysis and identity verification of the specific user; and
relaying the analysis results to the PC device of the plurality of photographer accounts before step (D).

6. The method for providing photography as claimed in claim 5, wherein the at least one set of facial bioinformatics data comprises at least one facial image of the specific user.

7. The method for providing photography as claimed in claim 5, wherein the at least one set of facial bioinformatics data comprises at least one facial video of the specific user.

8. The method for providing photography as claimed in claim 1 comprising the steps of:
providing a discovery control interface on the corresponding PC device of the specific user account through the remote server after step (A), wherein the discovery control interface comprises an on/off activation for the discovery of the location of the specific user account by the remote server; and
receiving the location of the specific user account from the corresponding PC device through the remote server in step (B), wherein the discovery control interface is activated by the specific user.

9. The method for providing photography as claimed in claim 1 comprising the steps of:
providing a time control interface on the corresponding PC device of the specific user account through the remote server after step (A), wherein the time control interface comprises a pre-determined time period for the discovery of the location of the specific user account by the remote server; and
receiving the location of the specific user account from the corresponding PC device through the remote server in step (B), wherein the current time is within the pre-determined time period.

10. The method for providing photography as claimed in claim 1 comprising the steps of:
protecting each photo being received from the PC device of the plurality of photographer accounts in step (E).

11. The method for providing photography as claimed in claim 10, wherein each photo is protected by watermark.

12. The method for providing photography as claimed in claim 10, wherein each photo is blurred.

13. The method for providing photography as claimed in claim 1 comprising the steps of:
receiving a price for each photo of the specific user account, wherein the price for each photo is set by a specific photographer account in step (F);
relaying the price for each photo to the corresponding PC device of the specific user account;
accepting a payment for at least one photo from the corresponding PC device of the specific user account;
sending the payment for at least one photo to the corresponding PC device of the plurality of specific photographer accounts; and
prompting the specific user account to download the at least one photo, wherein the protection of the at least one photo is removed.

14. The method for providing photography as claimed in claim 13, wherein the price for each photo is set by the administrator of the remote server.

15. The method for providing photography as claimed in claim 1 comprising the steps of:
receiving a purchase price for each desired photo from the corresponding PC device of the specific user account through the remote server after step (B); and
relaying the purchase price for each desired photo to the corresponding PC device of a plurality of photographer accounts through the remote server in step (C).

16. The method for providing photography as claimed in claim 15 comprising the steps of:
prompting the plurality of photographer accounts with the corresponding PC device to accept the purchase price for each desired photo through the remote server in step (C);
receiving the acceptance of the purchase price from the PC device of the plurality of photographer accounts before step (D).

17. The method for providing photography as claimed in claim 1 comprising the steps of:
relaying the confirmation from each of the plurality of photographer accounts to the corresponding PC device of the specific user account through the remote server before step (E).
